(19) United States
(12) Patent Application Publication
(10) Pub. No.: US 2008/0223032 A1
(43) Pub. Date: Sep. 18, 2008

(54) Systems And Methods For Generating Electricity Using Heat From Within The Earth

(75) Inventor: Theodore S. Sumrall, Fort Walton Beach, FL (US)

Correspondence Address: SUTHERLAND ASBILL & BRENNAN LLP, 999 PEACHTREE STREET, N.E., ATLANTA, GA, 30309, US

(73) Assignee: NOVEL ENGINEERING SOLUTIONS, INC., Fort Walton Beach, FL (US)

(21) Appl. No.: 12/054,033

(22) Filed: Mar. 24, 2008

Related U.S. Application Data
(63) Continuation-in-part of application No. 11/539,749, filed on Oct. 9, 2006.
Application No. 11/539,749 is a continuation-in-part of application No. 11/858,458, filed on Sep. 20, 2007.
(60) Provisional application No. 60/740,004, filed on Nov. 28, 2005.
(60) Provisional application No. 60/846,554, filed on Sep. 22, 2006.
(60) Provisional application No. 60/896,613, filed on Mar. 23, 2007.

(51) Int. Cl. F02G 1/043

(52) U.S. Cl. 60/531

(57) ABSTRACT

In one embodiment of the invention, a system may include a power generating means comprising a hot junction and a cold junction, a pump station, a high temperature source, and a low temperature source. The high temperature source may be thermally coupled by a first pipe system to the power generating means, wherein the high temperature source comprises heat from within the earth's surface. The low temperature source may be thermally coupled by a second pipe system to the cold junction, wherein the low temperature source comprises water from a body of water. The pump station is operable to cause a heat transfer medium to descend through the first pipe system to the high temperature source within the earth's surface and then to ascend through the first pipe system to the hot junction, generating electricity responsive in part to a temperature gradient between the hot junction and the cold junction.

### RELATED APPLICATION DATA

This application is a continuation-in-part of U.S. patent application Ser. No. 11/539,749 entitled “SYSTEMS AND METHODS FOR GENERATING ELECTRICITY USING A THERMOELECTRIC GENERATOR AND BODY OF WATER” filed on Oct. 9, 2006, which claims priority to U.S. Provisional Application No. 60/740,004 entitled “SYSTEMS AND METHODS FOR GENERATING ELECTRICITY USING A THERMOELECTRIC GENERATOR” filed on Nov. 28, 2005; and a continuation-in-part of U.S. patent application Ser. No. 11/858,458 entitled “SYSTEMS AND METHODS FOR GENERATING ELECTRICITY USING A STIRLING ENGINE” filed on Sep. 20, 2007, which claims priority to U.S. Provisional Application No. 60/846,554 entitled “SYSTEMS AND METHODS FOR GENERATING ELECTRICITY USING NATURAL WATER SOURCES AND HEAT FROM WITHIN THE EARTH IN CONJUNCTION WITH A STIRLING ENGINE” filed on Sep. 22, 2006, each of which are incorporated herein by reference in their entirety. This application also claims priority to U.S. Provisional Application No. 60/896,613 entitled “SYSTEMS AND METHODS FOR GENERATING ELECTRICITY USING NATURAL WATER SOURCES AND HEAT FROM THE EARTH IN CONJUNCTION WITH A POWER GENERATOR” filed on Mar. 23, 2007, which is incorporated herein by reference in its entirety.

### GOVERNMENT CONTRACT

The U.S. Government has a license in this application pursuant to Contract Number F08630-03-C-0133 awarded by the U.S. Department of Defense.

### TECHNICAL FIELD

This application relates generally to the field of electricity generation through the use of heat from within the earth's crust and more particularly to the use of systems and methods for generating electricity using heat from within the earth.

### BACKGROUND OF THE APPLICATION

Conventional systems for generating electricity for consumption and use by the public include nuclear power, fossil fuel powered steam generation plants and hydroelectric power. Operation and maintenance of these systems is expensive and utilizes significant natural resources and in some cases results in excessive pollution, either through hydrocarbon combustion or spent nuclear fuel rod disposal. Oil may be considered a non-renewable source of power, which leaves non-petroleum producing countries at the mercy of those which produce petroleum.

Nuclear power also has its problems. Currently, nuclear material is mined from the earth, refined and then utilized in a nuclear power plant. Sufficient amounts of Uranium-235 and/or plutonium are confined to a small space, often in the presence of a neutron moderator. The subsequent reaction produces heat which is converted to kinetic energy by means of a steam turbine and then a generator for electricity production. Nuclear power currently provides about 17% of the United States electricity and 7% of global energy. The cost for bringing a nuclear power plant on line is approximately $10-30 Billion. An international effort into the use of nuclear fusion for power is ongoing, but is not expected to be available in commercially viable form for several decades.

Therefore, there is a need in the art for systems and methods for generating clean electrical power cheaply without relying upon the import of petroleum materials or building of multi-billion dollar power plants. There is further a need for systems and methods for generating electricity using heat from within the earth in conjunction.

### SUMMARY OF THE INVENTION

Embodiments of the invention can address some or all of the needs described above. Embodiments of the invention are directed generally to systems and methods for generating electricity using heat from within the earth in conjunction.

According to an example embodiment of the invention, a system for producing electrical power is provided. The system may include a power generating means comprising a hot junction and a cold junction, a pump station, a high temperature source, and a low temperature source. The high temperature source may be thermally coupled by a first pipe system to the power generating means, wherein the high temperature source comprises heat from within the earth's surface. The first pipe system may comprise a closed path between the pump station and the hot junction, with the high temperature source in thermal communication with the first pipe system therebetween. The low temperature source may be thermally coupled by a second pipe system to the cold junction, wherein the low temperature source comprises water from a body of water. The pump station is operable to cause a heat transfer medium to descend through the first pipe system to the high temperature source within the earth's surface and then to ascend through the first pipe system to the hot junction. The power generating means generates electricity responsive in part to a temperature gradient between the hot junction and the cold junction.

According to another aspect of this embodiment, the power generation means may be one of a Stirling engine or a Rankin engine.

According to another embodiment of the invention, a system for producing electrical power is provided. The system includes a power generating means comprising a turbine, a pump station, a high temperature source, and a heat transfer medium. The high temperature source may be coupled by a first pipe system to the turbine of the power generating means, wherein the high temperature source comprises heat from within the earth's surface, and wherein the first pipe system comprises a closed path between the pump station and the turbine. The high temperature source is in thermal communication with the first pipe system therebetween. The pump station may be operable to cause the heat transfer medium to descend through the first pipe system to the high temperature source within the earth's surface and then to ascend through the first pipe system to the power generating means. The power generating means may generate electricity responsive in part to the ascension of the heat transfer medium to causing a rotational force therein.

According to another aspect of this embodiment, the power generation means may be one of Stirling ending, a Rankine engine, a flash power plant, a dry steam power plant, a binary power plant, or a flash/binary combined cycle power plant, a Sumrall energy cycle plant, or a Matteran energy cycle plant.

According to another embodiment of the invention, a system for producing electrical power is provided. The system may include a power generating means comprising a turbine, a pump station, a high temperature, and a heat transfer medium having a boiling point less than approximately 100 degrees Celsius. The high temperature source is coupled by a first pipe system to the turbine of the power generating means, wherein the high temperature source comprises heat from within the earth's surface. The first pipe system may comprise a closed path between the pump station and the turbine, with the high temperature source in thermal communication with the first pipe system therebetween. The pump station is operable to cause the heat transfer medium to descend through the first pipe system to the high temperature source within the earth's surface. Upon the high temperature source substantially vaporizing the heat transfer medium, the vaporized heat transfer medium ascends through the first pipe system to the turbine. The power generating means generates electricity responsive in part to the ascension of the vaporized heat transfer medium to the turbine causing a rotational force therein.

According to another aspect of this embodiment, the heat transfer medium may comprise isobutane.

According to yet another aspect of this embodiment, the turbine may be in gaseous communication with the pipe system.

According to another embodiment of the invention, a method for producing electrical power is provided. The method includes providing a power generating means comprising a turbine, and providing a pump station. The method may also include thermally coupling a high temperature source by a first pipe system to the turbine of the power generating means, wherein the high temperature source comprises heat from within the earth's surface, and wherein the first pipe system comprises a closed path between the pump station and the turbine, the high temperature source is in thermal communication with the first pipe system therebetween and causing a heat transfer medium to descend through the first pipe system to the high temperature source within the earth's surface and then to ascend through the first pipe system to the power generating means, wherein the power generating means generates electricity responsive in part to the ascension of the heat transfer medium to causing a rotational force therein.

According to one aspect of this embodiment, the power generation means may comprise one of a Stirling engine, a Rankine engine, a flash power plant, a dry steam power plant, a binary power plant, or a flash/binary combined cycle power plant, a Sumrall energy cycle plant, or a Matteran energy cycle plant.

Other embodiments and aspects of the invention will become apparent from the following description taken in conjunction with the following drawings.

### DETAILED DESCRIPTION OF THE DRAWINGS

Having thus described embodiments of the invention in general terms, reference will now be made to the accompanying drawings, which are not necessarily drawn to scale, and wherein:

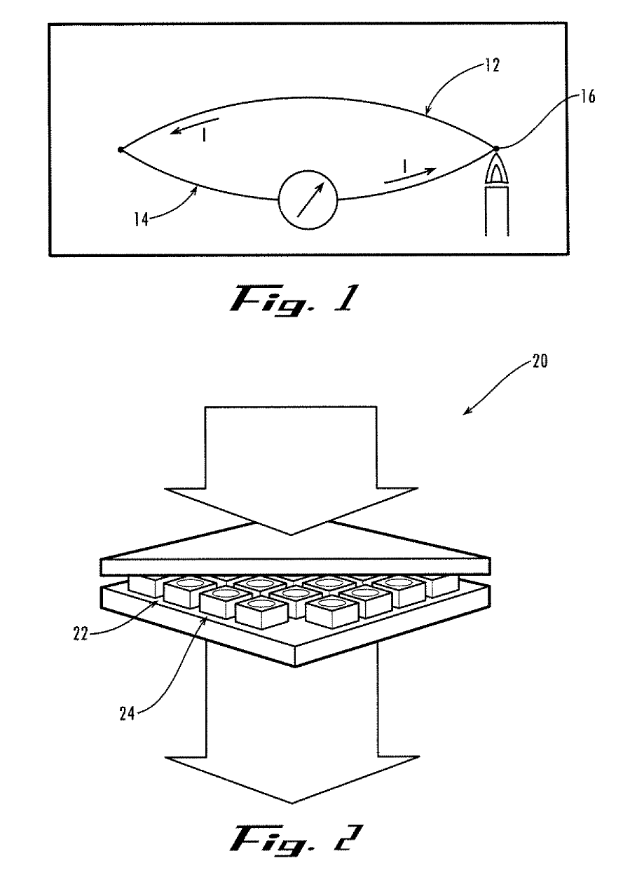

FIG. 1 is a diagram of the Seebeck Effect for thermoelectric systems according to an exemplary embodiment of the invention.

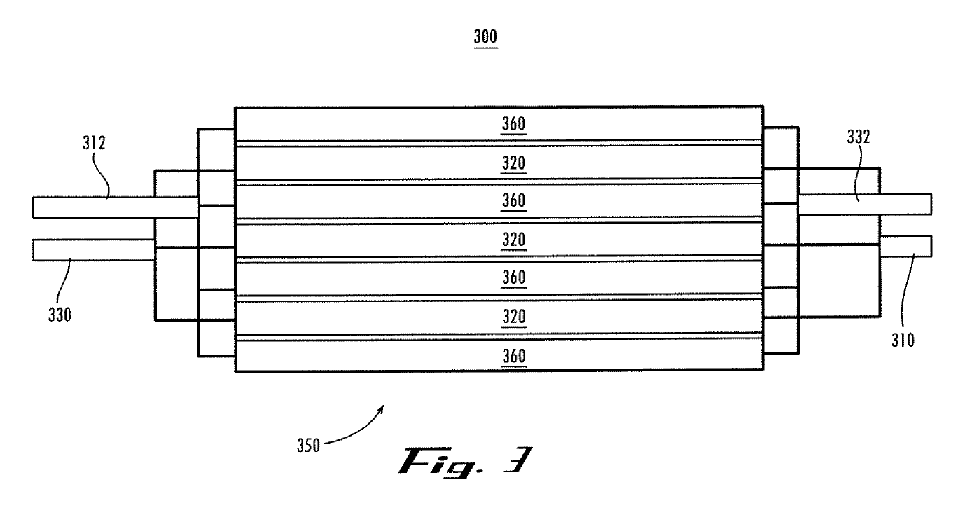

FIG. 2 is a thermopile of the thermoelectric system according to an exemplary embodiment of the invention.

FIG. 3 is a thermoelectric generator according to an exemplary embodiment of the invention.

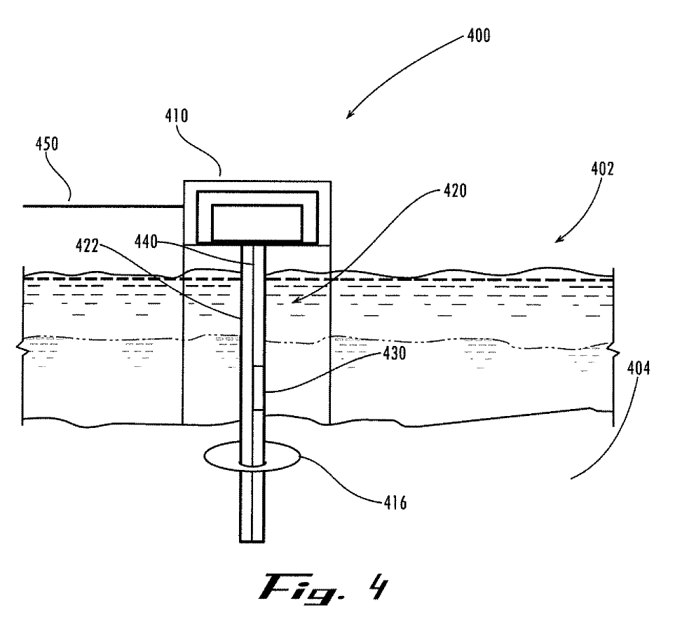

FIG. 4 is an illustration of a thermoelectric generation system according to an exemplary embodiment of the invention.

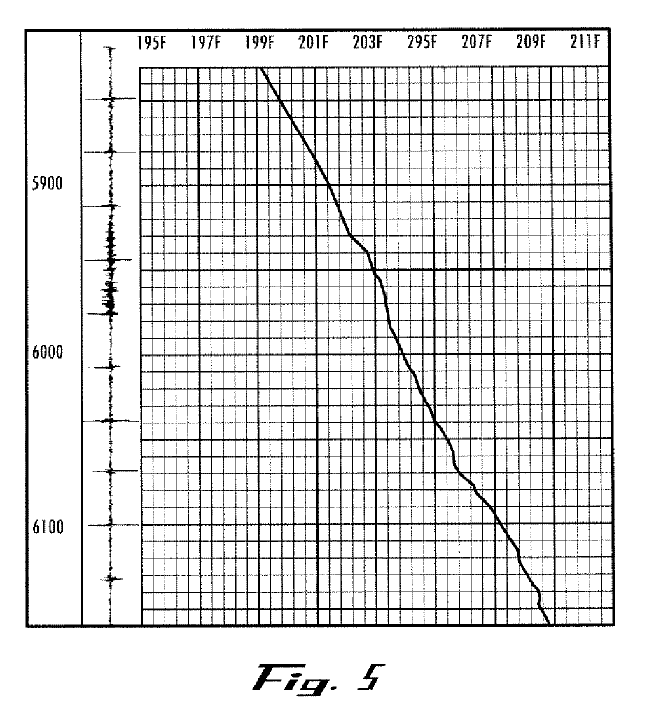

FIG. 5 is an illustration of temperatures within the earth's surface according to an exemplary embodiment of the invention.

FIG. 6 is an illustration of a pipe including an interior pipe and an exterior pipe according to an embodiment of the invention.

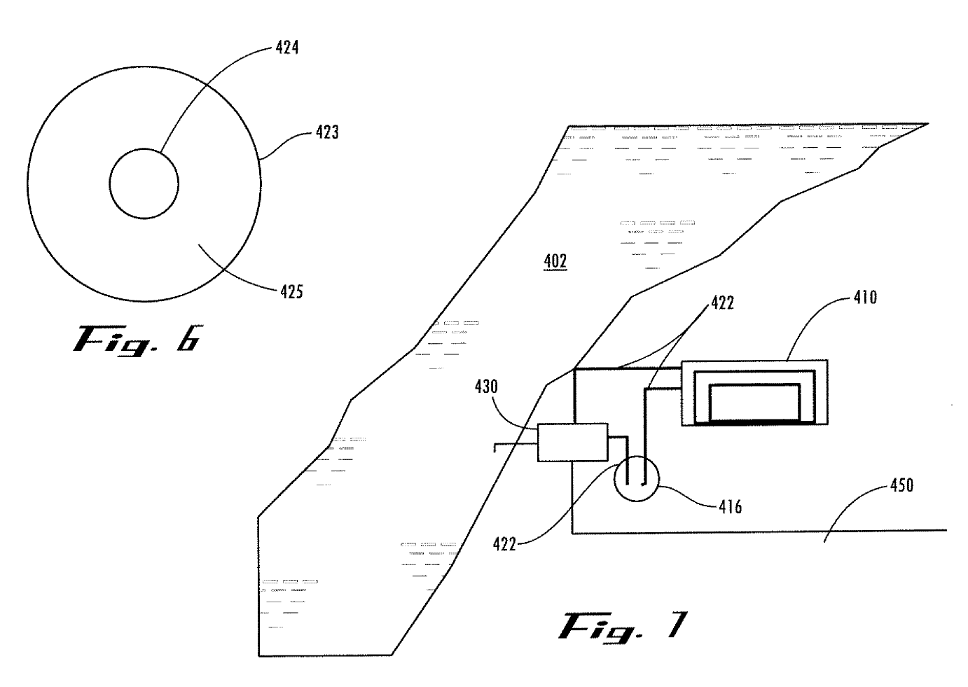

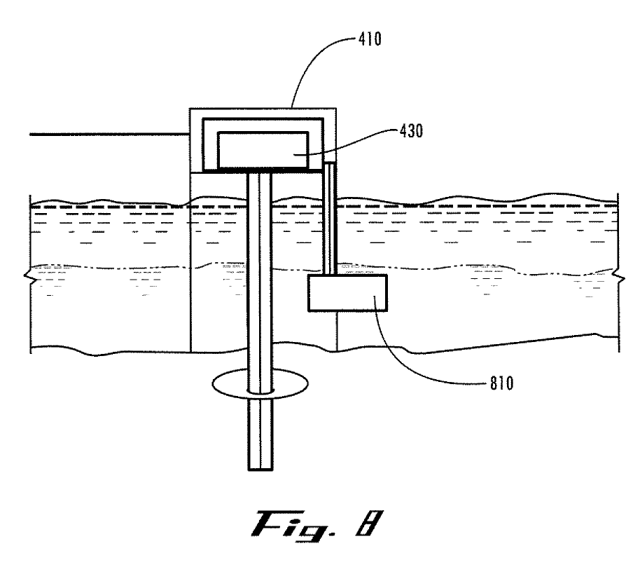

FIG. 7 is an illustration of a thermoelectric generation system according to an exemplary embodiment of the invention.

FIG. 8 is an illustration of a thermoelectric generation system according to an exemplary embodiment of the invention.

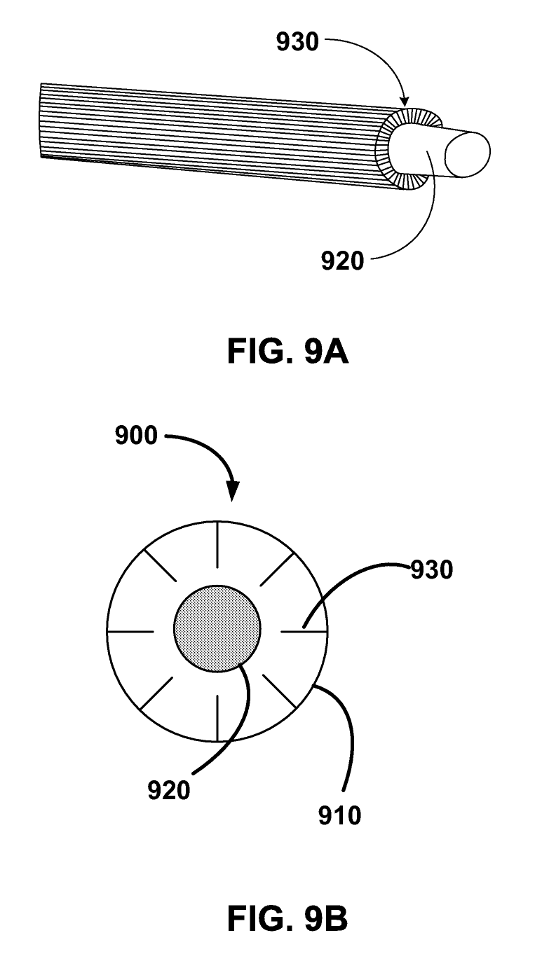

FIGS. 9A and 9B is an illustration of a pipe system according to an exemplary embodiment of the invention.

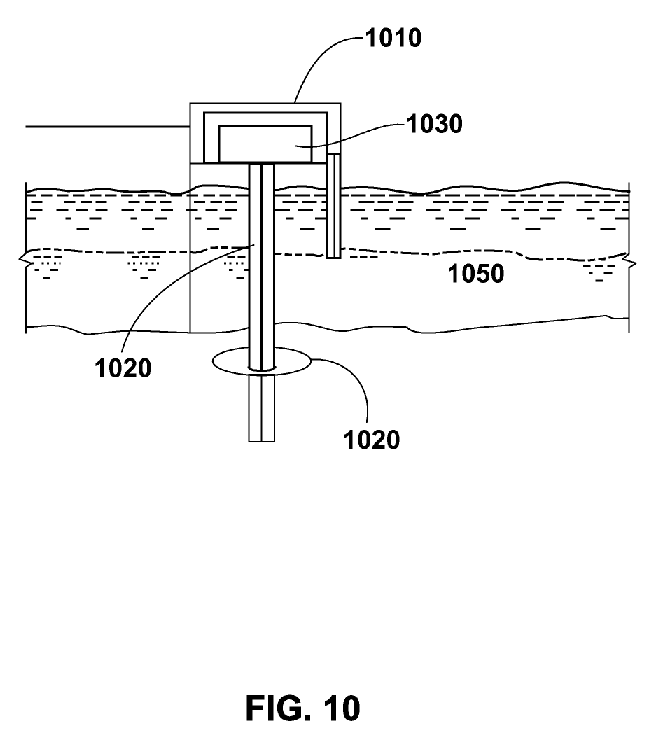

FIG. 10 is an illustration of a thermoelectric generation system according to an exemplary embodiment of the invention.

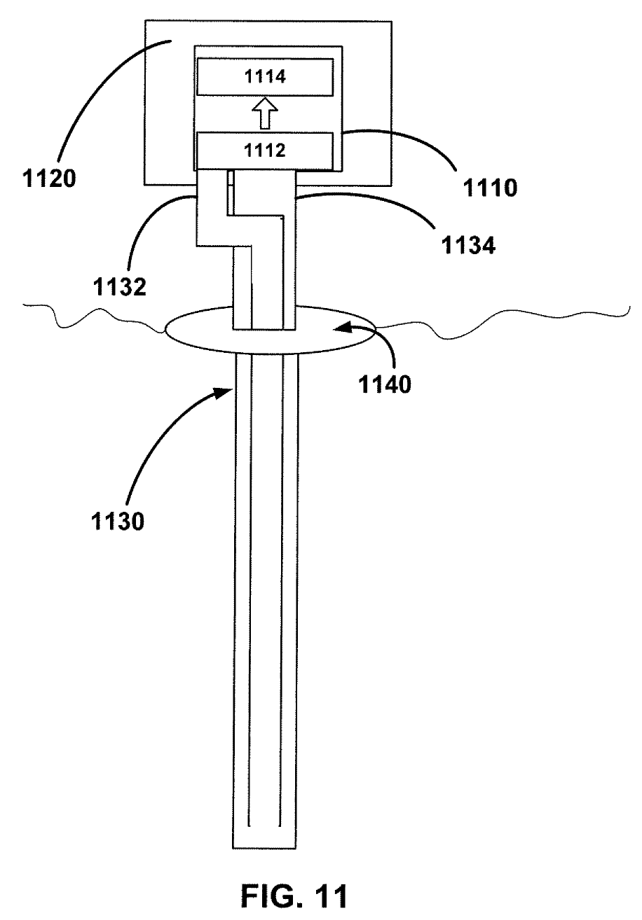

FIG. 11 is an illustration of a thermoelectric generation system according to an exemplary embodiment of the invention.

### DETAILED DESCRIPTION OF THE APPLICATION

The invention now will be described more fully hereinafter with reference to the accompanying drawings, in which an exemplary embodiment of the invention is shown. This application may, however, be embodied in many different forms and should not be construed as limited to the embodiments set forth herein; rather, this embodiment is provided so that this disclosure will be thorough and will fully convey the scope of the invention to those skilled in the art. Like numbers refer to like elements throughout.

The invention includes utilizing deep wells (for example, abandoned or non utilized oil and gas wells) which can be obtained for very little investment and fit them with a medium recirculation type system to provide heat energy for power generation means. For example, the power generation means may include thermoelectric generators, Stirling engines, Rankin engines, Matteran energy cycle engines, flash power plants, dry steam power plants, binary power plants, flash/binary combined cycles, and the like. The deep wells may generate heat energy while a separate lower temperature source may provide a cold source for creating a temperature differential, a heat sink, or the like, as is used by the various power generation means described herein. For example, the separate lower temperature source may be provided by water obtained from a variety of sources including an ocean, sea, gulf river, stream, creek, lake, spring, or from any underground source such as underground wells or from public water systems. The power generation means may be used to provide power for public, private and government consumption.

The invention has many inherit advantages resulting from the efficient, thoughtful design that takes advantage of available energy sources and limits the physical and ecological footprint and waste resulting from its use. For example, designed as a closed loop or substantially closed loop process, embodiments of the invention may reduce pollution and unnecessary introduction of non-natural materials to the surrounding environment when in use, including into the earth's surface, underground, and into the earth's atmosphere. Furthermore, the closed loop nature and the reliance on existing energy sources reduces the creation of additional waste or undesirable byproducts as are often generated with current geothermal energy generation systems. Through the use of heat energy already existing within the earth, embodiments of the invention may additionally provide an untapped alternative energy source, overcoming many of the fuel dependency problems currently faced. Embodiments of the invention may also be scalable through the inclusion of multiple energy generation means and multiple heat sources, providing an alternate energy source for local use and/or for contributing to larger private or public grids. Additionally, scalability may be achieved through economically prudent system construction, avoiding excessive construction costs, time, and space. Finally, embodiments of the invention create an opportunity to leverage existing energy already accessible via non-producing wells, such as spent wells or exploration wells, that otherwise may be unused or under utilized.

A High Temperature Source with a Thermoelectric Generator

A first example embodiment of the invention may include a thermoelectric generator comprising a thermopile, a hot junction, and a cold junction. The hot junction of the thermopile may be coupled to a high temperature source comprising heat from within the earth's surface. Additionally, the cold junction of the thermopile may be coupled to a low temperature source from a body of water, which may be geographically separated from the cold junction. The high temperature source and the low temperature source thus may create a temperature gradient at the thermopile for generating electricity.

As illustrated in FIG. 17 continuously flowing electrical current may be created when a first wire 12 of a first material is joined with a second wire 14 of a second material and then heated at one of the junction ends 16. This is known as the Seebeck Effect. The Seebeck effect has two main applications: Temperature Measurement (thermocouple) and Power Generation. A thermoelectric system is one that operates on a circuit that incorporates both thermal and electrical effects to convert heat energy into electrical energy or electrical energy to a decreasing temperature gradient. The combination of the two or more wires creates a thermopile 10 that is integrated into a thermoelectric system. When employed for the purposes of power generation, the voltage generated is a function of the temperature difference and the materials of the two wires used. A thermoelectric generator has a power cycle closely related to a heat engine cycle with electrons serving as the working fluid and can be employed as power generators. Heat is transferred from a high temperature source to a hot junction and then rejected to a low temperature sink from a cold junction or directly to the atmosphere. A temperature gradient between the temperatures of the hot junction and the cold junction generates a voltage potential and the generation of electrical power. Semi-conductors may be used to significantly increase the voltage output of thermoelectric generators.

FIG. 2 illustrates a thermopile 20 constructed with a n-typed semiconductor material 22 and a p-type semiconductor material 24. For increased electrical current, the n-type materials 22 are heavily doped to create excess electrons, while p-type materials 24 are used to create a deficiency of electrons.

Thermoelectric generator technology is a functional, viable and continuous long-term electrical power source. Due to the accessibility of temperature gradients occurring in natural and man-made environments, thermoelectric generators can provide a continuous power supply in the form of electricity. One of the most abundant, common, and accessible sources of energy is environmental heat, especially heat contained within the earth's crust.

FIG. 3 illustrates an embodiment of the thermoelectric generator. The thermoelectric generator 300 may include an input 310 to a hot junction 320 and an output 330 to the hot junction 340. The hot junction 320 may include any source of heat for heat transfer. In an exemplary embodiment, the source of heat is a hot plate 340. The hot plate 340 may be metal or any other conductive material. The hot plate 340 may interface the thermopile 350 to provide heat to the thermopile through conduction, convection, radiation, or any other heat transfer means. One of ordinary skill in the art will appreciate that any thermoelectric generator may be used herein and is not limited to this embodiment. Any system that allows the heat to access the thermopile is contemplated herein.

The thermoelectric generator 300 may further include a cold junction 360. The cold junction 360 may include a cold plate 370 for heat transfer. Alternatively, heat may be radiated or convected away from the cold junction. The cold plate 370 may be metal or any other conductive material. The cold plate 370 may interface the thermopile 350 to provide a conductive heat sink. Voltage potential may be created across the thermopile 350 from a temperature gradient between the temperature of the hot plate 340 and the temperature of the cold plate 370. The greater the temperature gradient, the more electrical power may be generated. One of ordinary skill in the art will appreciate that any thermoelectric generator may be used herein and is not limited to this embodiment.

Any system that provides a heat sink that interfaces thermopile is contemplated herein, including naturally occurring sources of heat absorption such as a fluid. In an exemplary embodiment, the fluid is water. Water may be obtained from any source including an ocean, sea, gulf, river, stream, creek, lake, spring, or from any underground source such as underground wells or from public water systems for the purposes of this application. Since the water is used to absorb heat, water from a public water system used as the heat sink herein may serve an ancillary purpose of preheating the water to decrease the power required by the public, government, or industry to heat the water for any desired use. Water or any fluid as the low temperature source provides a technical benefit over air or gas by having a higher heat transfer coefficient and therefore providing better heat transfer with the cold junction.

FIG. 4 illustrates an exemplary embodiment of a thermoelectric generation system 400. A thermoelectric generator may be used in the thermoelectric generation system to produce electrical power from a temperature gradient between a low temperature source and a high temperature source. The thermoelectric generation system 400 may be located in or near a body of water 402 including but not limited to an ocean, gulf, sea, lake, river, spring, creek, or any other relatively cooler body of water. The thermoelectric generation system 400 utilizes the body of water 402 as the low temperature source for the thermoelectric generator.

The body of water 402 can provide significantly lower temperatures to the thermoelectric generator to increase the temperature gradient. In a body of water 402, such as an ocean, gulf, sea, or lake, the temperature of the water decreases with depth. At a depth commonly referred to as the thermocline, the water temperature significantly decreases. The depth at which a thermocline occurs averages between 30 and 50 meters, and varies throughout the world. It is preferred for the low temperature source to be water at a depth below the thermocline to provide a continuous source of cold water, and preferably in a current to allow a continuous flow of cool water so that the water is not stagnant and therefore rises in temperature throughout energy production operations. Additionally, location of the power plant adjacent to some other surface body of relatively cooler water will allow the water to flow through the plant and then be discharged with minimal thermal change of the water.

Accordingly, the low temperature source may either be in direct contact with the cold junction, or alternatively may be geographically separated from the cold junction and fluidly communicate by a pipe or other means of medium transport.

The high temperature source may be provided from within the earth's crust 404. The earth provides a continuous, inexpensive source of extremely high heat. As illustrated in FIG. 5, the temperature within the earth generally increases towards the core of the earth at an average rate of approximately 1 degree Fahrenheit for every 60 feet of depth. Therefore, locations deep within the earth may be used as the high temperature source for the hot junction of the thermoelectric generator. Locations within the earth may be accessed through drilling or other means for creating a hole 416 in the ground and water or some other type of heat transfer medium circulated through the hole and brought to or near the surface to allow for heat transfer to occur by the employment of high efficiency pumps or some other method.

Certain holes, commonly referred to as dry holes may be used to access the high temperatures within the earth's crust. Dry holes typically exist from the unsuccessful efforts of the petroleum industry to locate oil or gas. The petroleum industry drills wells deep into the earth's crust for the exploration for petroleum. The overwhelming majority of exploration wells drilled throughout the world do not locate petroleum and are thereby indicated as “dry holes.” Dry holes provide relatively easy access to the subterranean levels and high temperature conditions. Dry holes may be located on land or in a body of water. Dry holes may reach depths in excess of 30,000 feet. However, one of ordinary skill in the art will appreciate that dry holes may be any depth. As shown in FIG. 5, temperatures in the dry holes can reach extremely high temperatures. In the exemplary embodiment of FIG. 5, temperatures in that particular dry well are approximately 209 degrees F. at 6100 feet. One of ordinary skill in the art will appreciate that this application is not limited to the use of dry holes and may include any hole in the earth's crust which can provide a heat source including holes drilled for use by a thermoelectric generator as well as expended oil and gas wells.

Referring again to FIG. 4, the thermoelectric generation system may include a pump station 410, a pipe system 420, a thermoelectric generator 430, and a fluid 440. The thermoelectric generation system may be positioned in or proximate to a body of water 402. The pump station 410 may include a pump and associated housing for the pump. The pump may be any commercially available or specially designed pump that is capable of forcing fluid to flow at a suitable volumetric rate. The pump station 410 may be located on land, above the water surface, or underneath the water. The pump station 410 is connected to the pipe system 420. The pipe system 420 includes at least one pipe 422. The pipe 422 may include an inner bore for carrying fluid 440 to be heated by the earth. The inner bore may be any suitable diameter that allows sufficient fluid 440 to be pumped through the pipe system. The pipe 422 extends from the pump station 410 into the hole 416 and may be substantially U-shaped such that the pipe 422 ascends out of the hole.

The pipe system 420 may interface a hot junction 320 of the thermoelectric generator 430. The inner bore of the pipe 422 of the pipe system 420 is accessible to an input of the hot junction 320 of the thermoelectric generator 430. The pipe system 420 extends from an output of the hot junction 320 of the thermoelectric generator 430 to return to the pump station 410.

Accordingly, the pipe system 420 may be configured in a closed loop or a substantially closed loop configuration between the pump station 410 and the thermoelectric generator 430. More specifically, the heat transfer medium being pumped from the pump station 410 into the high temperature source existing under the earth's surface (for example, within an existing well) and back to the surface to the hot junction 320 of the thermoelectric generator may never become exposed to the surrounding elements within and be entirely contained in the pipe system 420 until its interface at the hot junction. However, it is appreciated that it may be necessary to add, replace, or replenish the heat transfer medium at the pump station 410.

In another exemplary embodiment illustrated in FIG. 6, the pipe system may include an exterior pipe 423 and an interior pipe 424 such that an annulus 425 exists between the interior pipe 424 and the exterior pipe 423. In this exemplary embodiment, the fluid 440 may be pumped into the hole through the interior pipe 424, and the fluid 440 heated by the earth may be pumped out the hole through the annulus 425 to the hot junction 320 of the thermoelectric generator 430.

Alternatively, the embodiment illustrated in FIG. 6 may allow for the fluid 440 to be pumped into the hole through the annulus 425 and pumped out of the hole through the interior pipe 424. It is appreciated that, depending upon the surrounding environment and temperatures that the pipe system 420 will be interfacing, the returning fluid pumped downward through the annulus 425 may additionally insulate the heated medium pumped up through the interior pipe 424.

FIGS. 9A and 9B illustrate another exemplary embodiment of a pipe system 900 having both an exterior pipe 910 and an interior pipe 920, as is described above with reference to FIG. 6. As illustrated by FIG. 9A, the interior pipe 920 includes a plurality of fins 930 affixed to the exterior surface of the pipe, and which may run along at least a portion of the pipe length and extend radially outward. In one example, the fins 930 may run substantially the entire length of the pipe. In another example, however, the fins 930 may be affixed to the interior pipe 920 along a length at or near the distal portion of the pipe system 900. The fins 930 may facilitate geothermal heat transfer from the earth to the medium being circulated therethrough, and further facilitate heat dissipation within the medium. Thus, in an embodiment of the pipe system 900 including fins only at a distal portion of the pipe system 900 would provide the increased heat transfer mechanism at or near where the deepest portion of the pipe system where the geothermal energy is the greatest. Alternatively, in another example embodiment illustrated by FIG. 9B, the plurality of fins 930 may be affixed to the exterior pipe 910 and extend to radially toward the interior pipe 920. It is further appreciated that the fins 930 may be affixed to both the exterior pipe 910 and the interior pipe 910 and extending therebetween. The fins 930 may be constructed of materials having a high thermal conductivity, as are known.

Fins as described may also be employed in embodiments having a pipe system not including both an interior or exterior pipe, such as substantially U-shaped pipe system as described with reference to FIG. 4. In these embodiments, the fins may be affixed to the interior surface of the pipe and extend radially inward, further improving geothermal heat transfer from the earth to the fluid pumped therethrough.

The fluid 440 is forced through the pump using the pump station 410. The fluid 440 is circulated through the pipe 422, the hot junction 320 of the thermoelectric generator 430, and the pump station 410 using the pump. Additional fluid may be added to the pipe system 420 either continuously or when needed by the system to account for any loss of fluid during operation of the pipe system and pump station. However, one of ordinary skill in the art will recognize that other methods of bringing the heated fluid to or near the surface may be employed.

The fluid 440 within the pipe 422 is heated by the earth as it descends from the pump station 410 towards the bottom of the hole 416. The fluid 440 may be heated to approach the temperature of the earth in the hole 416. In an exemplary embodiment, the fluid 440 may be heated in excess of 200 degrees Fahrenheit. After the fluid 440 reaches the lowest point of the pipe 422, the heated fluid then ascends out of the hole 416 and into the input of the hot junction 320 of the thermoelectric generator 430.

The heated fluid in the pipes 422 may be the high temperature source and is thermally coupled to the hot junction 320 of the thermoelectric generator 430. The fluid exits the inner bore of the pipe 422 and enters the input of the hot junction 320 of the thermoelectric generator 430. The fluid 440 then may exit through the output 330 of the hot junction 320 of the thermoelectric generator 430 through the inner bore of the pipe 422. The fluid 440 continues to the pump station 410 to close the pumping cycle of the fluid. The pump station may include any pump that is operable to pump the fluid 440 through the pipe system 420 and the thermoelectric generator 430 at an appropriate volumetric rate. Furthermore, the thermoelectric generation system may operate as either a closed system or an open system.

The fluid 440 may include any fluid that is capable of being heated by the earth and capable of retaining a substantial portion of the heat for delivery to the hot junction of the thermoelectric generator. In an exemplary embodiment, the fluid is water, however, other fluids may be employed to reduce corrosion and to allow heating well above the boiling point of water.

The thermoelectric generator 430 may be located in the body of water 402 and in communication with the pipe system 420. The body of water 402 is used as the low temperature source for the cold junction 360 of the thermoelectric generator. In the exemplary embodiment of FIG. 4, the thermoelectric generator 430 is located beneath the thermocline of the body of water 402 so that the cold junction 360 may access the low temperature water below the thermocline. In an exemplary embodiment, the thermoelectric generator 430 may be located in a current stream in the body of water 402 to access a flow of the water. The body of water 402 provides the low temperature source for cold junction 360 of the thermoelectric generator 430. The cold junction 360 may be outwardly exposed to the water in the body of water 402. The cold junction 360 may be sufficiently protected to prevent corrosion. The water in the body of water 402 also may be channeled into the cold junction 360 of the thermoelectric generator. The cold junction 360 may include an input for receiving the water and an output for exiting the cold water. The water may flow through the cold junction 360 to provide the low temperature source to the cold junction 360 of the thermoelectric generator.

In an exemplary embodiment, the high temperature source may be between 100 degrees Fahrenheit and 600 degrees Fahrenheit and the low temperature source may be between approximately 32 and 130 degrees Fahrenheit. One of ordinary skill in the art will appreciate that the high temperature source and low temperature source are not limited to these temperature ranges but may be any appropriate temperature ranges. The temperature gradient (ΔT) between the hot junction and the cold junction may be between 470 and 68 degrees in the exemplary embodiment. One of ordinary skill in the art will appreciate that the temperature gradient is not limited to this range but may be any temperature gradient.

The thermoelectric generator 430 creates a voltage potential across the hot junction 320 and the cold junction 360 of the thermoelectric generator. The use of the heat from the earth to control the temperature of the hot junction 320 and the coldness of the water to control the temperature of the cold junction 360 maximizes the temperature gradient and produces significant amounts of electrical power. The electrical power may be created as a direct current. The direct current may be transformed to an alternating current. A three-phase current may also be created. The electricity generated from the thermoelectric generator 430 may be transmitted through power lines 450 to any destination. In an exemplary embodiment, existing power transfer facilities and power conduction lines 450 may provide power to any current or newly created electrical grid network.

In another embodiment, the high temperature source may be used in conjunction with a steam powered generator. Fluid may be pumped through a pipe system into the earth's crust. The fluid may then be heated by the earth's crust and pumped to the surface. Using the high temperature source to heat the fluid may minimize the power required to operate a steam powered generator by preheating the water to the steam plants. The cost of heating the fluid to its boiling point, therefore, will be significantly reduced at hydrocarbon powered or other types of electrical plants if the fluid can be brought to a higher temperature as a result of heating within the earth's crust. For example, if the fluid is water, the high temperature source may heat the water to or near its boiling point. The water then could be converted to steam for use in the steam power generator. If the fluid is a fluid such as oil that has a boiling point greater than water, the fluid can be heated above 212 degrees Fahrenheit such that it can transfer heat through a heat exchanger to water in the steam powered generator to be converted to steam without the need of any or very little fossil fuels or other energy sources. The steam powered generator may be used in conjunction with the thermoelectric generation system or completely separate therefrom.

In another embodiment of the thermoelectric generation system illustrated in FIG. 7, the hole 416 may be located on the land proximate to a body of water. The hole 416 may provide the high temperature source for the hot junction as described previously. The body of water 402 may provide the low temperature source for the cold junction. The body of water 402 may be a river, spring, creek, lake, or any other cold water supply. The cold junction 360 of the thermoelectric generator 430 is thermally coupled to the body of water 402. The cold junction 360 may interface directly with the body of water 402 or the body of water may be directed to the cold junction 360 using a pipe 422 of a pipe system or other means of channeling the water such as a heat exchanger. The cold junction 360 is cooled to approximately the temperature of the water interfacing the cold junction. The thermoelectric generator 430 creates a voltage potential across the hot junction 320 and the cold junction 360 of the thermoelectric generator. The use of the heat from the earth to control the temperature of the hot junction 320 and the coldness of the surface or near surface water to control the temperature of the cold junction 360 maximizes the temperature gradient and produces significant amounts of electrical power through the employment of the thermoelectric modules. The electricity generated from the thermoelectric generator 430 may transmitted through power lines 450 to any destination.

In another embodiment of the thermoelectric generation system illustrated in FIG. 8, the low temperature source for the cold junction 360 may be water from a chiller device 810 residing below the surface of the earth. Due to the low temperatures below the earth's surface, the chiller device 810 may be used to lower the temperature of the water. In an exemplary embodiment, the chiller device may be placed at a depth up to approximately 300 feet below the surface. At approximately 300 feet below the surface, the temperature generally begins to increase with depth. One of ordinary skill in the art will appreciate that the 300 feet level is only an approximation and that the depth may vary depending on location on the earth and is therefore not limited to the 300 feet approximation. The chiller device 810 may be powered from electricity generated from the thermoelectric generator.

The utilization of water as the medium for heat transfer from deep within the earth's crust may cause corrosion of a metal pipe system. Hot water, especially when containing oxygen, may rapidly corrode metal. To reduce corrosion, a de-oxygenation mechanism, such as a high vacuum, may be employed to remove oxygen from the water. Alternatively, non-corrosive metals such stainless steel may be used for the pipe system. In another embodiment, the pipe system may include high temperature resistant and non-corrosive plastic piping. An exemplary embodiment of the plastic piping is piping manufactured from PARMAX® materials. One of ordinary skill in the art will appreciated that any non-corrosive and temperature resistant plastic may be used. In yet another embodiment, corrosive preventative substances may be used to minimize corrosion. For example, chromates or other chemicals may be used. As an alternative to water, a non-corrosive fluid such as a synthetic oil may be used to absorb the heat from within the earth's crust for the high temperature source. Oil has the added advantage of being able to be heated to a higher temperature than water and therefore more power may be drawn from the thermoelectric generation system in this manner.

The thermoelectric generator can be protected from the low temperature source during operation to extend the life of the thermoelectric generator. Protection may be in the form of chemical protection or any other source. The cold junction may include ceramic materials to resist corrosion from the water. The thermoelectric generator also may be sealed such that water does not engage or corrode the thermopiles.

The thermoelectric generator may include off-the-shelf thermopiles. The thermoelectric generators also may employ specially designed thermopiles, such as Quantum Well Thermoelectric Generators, that will substantially increase power generation.

The thermoelectric generator also may employ nano wires to increase the efficiency of the system. The nano wires increases the density of states. The nano wires may be arranged in a substantially parallel array to transport generated electricity. The thermoelectric generator also may include quantum dots to increase the efficiency of the system and lowers the thermal conductivity of the system.

In another embodiment of the thermoelectric generation system, the high temperature source for the hot junction may be from a mud pit. Mud from the mud pit is used as a drilling fluid for oil well drilling. The mud extends to the bottom of the hole being drilled for oil exploration. The mud is heated from the drilling and the high temperatures from within the earth's surface. The hot junction of the thermoelectric generator may interface the mud pit to access the high temperature of the mud. The high temperature of the mud may be used to increase the change in temperature across the thermopile and to increase electrical generation.

The thermoelectric generation system may have several advantages over conventional systems of power generation. For example, the thermoelectric generation system has minimal pollution concerns due in part to its operation as a closed loop system and will rely upon minimal, if any, introduction of non-natural materials. The thermoelectric generation system will have minimal waste and minimal atmospheric emissions. The thermoelectric generation system also is completely renewable. The thermoelectric generation system also may be scaled down to a level which can provide power for a local area. The thermoelectric generation system may be inexpensive to construct and operate compared to conventional power systems and also may take advantage of non-producing oil wells instead of having to cap the wells that are non-productive or to drill new holes.

A High Temperature Source with Alternative Power Generating Means

In a second example embodiment, the invention may include alternative power generating means, instead of a thermoelectric generator, as described above. For example, the alternative power generating means may include Stirling engines, Rankin engines, Matteran energy cycle engines, flash power plants, dry steam power plants, binary power plants, flash/binary combined cycles, and the like. By way of illustration, Sterling engines are described as an illustrative embodiment; though it is appreciated that the power generation system may include other power generation means, such as, Rankin engines, Matteran energy cycle engines, flash power plants, dry steam power plants, binary power plants, flash/binary combined cycles, and the like.

A Stirling engine is a heat engine that is vastly different from typical internal-combustion engines, and can be much more efficient than a gasoline or diesel engine. Today, however, Stirling engine use is typically limited to specialized applications, such as in submarines or as auxiliary power generators for yachts, where quiet operation is important. A Stirling engine uses the Stirling cycle, which is unlike the cycles used in internal-combustion engines, operating under the principles of the Carnot cycle. Example Stirling engines may include an alpha-type or beta-type Stirling engine using a single displacer piston, or a gamma-type Stirling engine using at least a two-piston configuration. The gasses used inside a Stirling engine do not escape the engine. There are no exhaust valves that vent high-pressure gasses, as in a gasoline or diesel engine, and combustion does not occur. Because of this, Stirling engines are very quiet.

An exemplary embodiment of a Stirling engine may include a cylindrical hot chamber with a piston, a cylindrical cold chamber with a piston, a gas, and a connecting pipe. A high temperature source may be applied or thermally coupled to the hot chamber to increase the temperature of the gas within the hot chamber. Heat from the high temperature source may be transferred to the gas through conduction, convection, radiation or any other means. A low temperature source may be applied or thermally coupled to the cold chamber to decrease the temperature of the gas within the cold chamber. Heat from the gas may be extracted by the cold temperature source through conduction, convection, radiation or any other means.

As known by those of ordinary skill in the art, the Stirling engine operates by pressurizing and depressurizing the gas through the application of a high temperature source to the hot chamber and application of a low temperature source to the cold chamber. The efficiency and power generated by the Stirling engine also may be increased through the use of an increased high temperature source and a decreased low temperature source to create a substantial temperature gradient across the hot chamber and the cold chamber. The temperature gradient across the hot and cold chambers will increase the pressure distribution across the engine which causes the pistons, to more actively move. Thus, the greater the temperature difference between the hot and cold heat exchangers, the more efficient the Stirling engine operates. The pistons, may be connected to a shaft such that the movement of the pistons causes the shaft to rotate. An electric generator may be attached to the shaft to convert the mechanical energy of the rotating shaft to electricity.

An example embodiment of this invention employing a Stirling engine is illustrated in FIG. 10. The Stirling engine generation system may include a pump station 1010, a Stirling engine generator 1030 (which as referred to herein includes both a Stirling engine and an electrical generator for the generation of electricity), a pipe system 1020 placed within a deep well or other hole 1040 in the earth's crust, and a heat transfer medium flowing through the pipe system 1020, in much the same manner as described with reference to FIGS. 4-9 and the embodiments employing a thermoelectric generator. In one example embodiment, the Stirling engine generation system may be positioned in or proximate to a body of water 1050. In other example embodiments, the Stirling engine generation system may be geographically separated from the body of water 1050, and optionally be in thermal communication therewith, for example, by a secondary pipe system, as illustrated in FIG. 7.

The pipe system 1020 interfaces with a hot junction (also referred to as a hot heat exchanger) of the Stirling engine generator, so as to provide thermal communication between the heat transfer medium within the pipe system 1020 and the hot chamber (also referred to herein as the “hot junction” or the “hot heat exchanger”). In a manner similar to that described above with reference to FIGS. 4-8, the heat transfer medium (for example a fluid such as water) is pumped from the pump station 1010 down the pipe system 1020 for heating. The transfer medium within the pipe system 1020 is heated by the earth as it descends from the pump station towards the bottom of the hole 1040. The heat transfer medium may be heated to approach the temperature of the earth in the hole 1040. In an exemplary embodiment, the heat transfer medium may be heated in excess of 200 degrees Fahrenheit. After reaching the lowest point of the pipe system 1020, the heated medium then ascends out of the hole 1040 and toward the hot chamber of the Stirling engine generator 1030.

The heated medium within the pipes provides a high temperature source for thermally interfacing with the hot heat exchanger of the Stirling engine generator 1030. Accordingly, the heat available within the deep well or hole 1040 provides a very high temperature source in thermal communication with the Stirling engine for heating the gas therein. The heat transfer medium may include any fluid that is capable of being heated by the earth and capable of retaining a substantial portion of the heat for delivery to the hot chamber of the Stirling engine generator 1030. In an exemplary embodiment, the fluid is water, however, other fluids may be employed to reduce corrosion and to allow heating well above the boiling point of water.

The cold heat exchanger or the cold chamber (also referred to herein as the “cold junction” or the “cold heat exchanger”) of the Stirling engine generator may be in thermal communication with a low temperature source, such as a body of water as further described above with reference to FIGS. 4-8. In an exemplary embodiment of the Stirling engine generator, the cold chamber of the generator is in thermal communication with the body of water at a point beneath the thermocline of the body of water so that the cold chamber may access the low temperature water below the thermocline or cool water from the thermocline may be pumped to the surface to provide a lower temperature heat sink.

In an exemplary embodiment, the high temperature source may be between 100 degrees Fahrenheit and 600 degrees Fahrenheit and the low temperature source may be approximately 32 and 130 degrees Fahrenheit. It is appreciated, however, that the high temperature source and low temperature source are not limited to these temperature ranges but may be any appropriate temperature ranges. The temperature gradient (ΔT) between the hot junction and the cold junction may be between approximately 470 degrees and approximately 68 degrees in an exemplary embodiment. Again, it is appreciated, however, that the temperature gradient is not limited to this range but may be any temperature gradient. Thus, the use of the heat energy available from within the earth's crust to increase the temperature at the hot heat exchanger of the Stirling engine generator and the coldness of the water to cool the temperature of the cold heat exchanger, creating a more powerful heat sink for dissipating heat from the engine, maximizes the temperature gradient and produces significant amounts of electrical power. The electrical power may be created as a direct current. The direct current may be transformed to an alternating current. A three-phase current may also be created. The electricity generated from the Stirling engine generator may be transmitted through power lines to any destination. In an exemplary embodiment, existing power transfer facilities and power conduction lines may provide power to any current or newly created electrical grid network.

As stated previously, other power generation means that gain advantage with larger temperature differentials may be used in concert with the heat energy transferred from the earth's crust by the systems and methods described herein. In one example, a Rankin engine may be used in much the same manner as either the thermoelectric generator or the Stirling engine, cycling the heat transfer medium from the pump station to the bottom of the well or hole, then through the Rankin engine and back, while also leveraging a low temperature source such as a body of water.

FIG. 11 illustrates another example embodiment, including a power generating means 1110, which may include a turbine 1112 and generator 1114, a pump station 1120, and a pipe system 1130 extending into a deep well or hole 1140 within the earth's crust, as described in detail with reference to FIGS. 4-10. As illustrated in FIG. 11, the pipe system may include an inner pipe 1132 and an exterior pipe 1134, as is described more fully with reference to FIGS. 6 and 9. However, it is appreciated that any of these exemplary embodiments may employ other pipe configurations, such as, for example, a substantially U-shaped pipe.

It is further appreciated that the pipe system 1130 may configured as a heat pipe or a thermo siphon, as are known. A heat pipe is a heat transfer mechanism operable to transport significant quantities of heat with a small temperature gradients. Inside a heat pipe, at or near the high temperature source, the heat transfer fluid therein vaporizes and naturally flows and condenses on or near a lower temperature interface such as at the power generating means 1110. After condensing, the liquid falls or is moved by capillary action back to the high temperature source to evaporate again and repeat the cycle. Accordingly, in embodiments where the pipe system 1130 is configured as a heat pipe, heat from the bottom of a hole 1140 can quickly be transferred to the power generating means 1110, and the heat extracted and used to power the turbine 1112. It is further appreciated that while the heat pipe and thermo siphon are described in reference to FIG. 11, any embodiments may employ heat pipe technology to configure some or all of the pipe systems used therein.

The power generating means 1110 may include a Sumrall energy cycle plant, a Matteran energy cycle plant, a flash power plant, a dry steam power plant, a binary power plant, a flash/binary combined cycle power plant, and the like, each of which are more fully described with reference to FIG. 11.

In an example embodiment using a Sumrall energy cycle plant as the power generating means 1110, the heat transfer medium may be one that is liquid at normal room temperatures, but has a lower boiling point than water, allowing it to vaporize at lower temperatures. In the Sumrall energy cycle, the low boiling point medium is delivered directly down the pipe system 1130, rather than as a secondary fluid interfacing through a heat exchanger with the primary heat transfer medium delivered down the pipe, as in a binary cycle power plant as is known. Example media for use in the Sumrall energy cycle may include isobutane or other materials vaporizing below 100 degrees Celsius. Accordingly, a medium with a lower boiling point has a lower heat of vaporization and thus can be vaporized directly by the heat reached within the pipe system 1130 at the bottom of the hole or well 1140 and the vapor transported directly to the turbine 1112 in the power generation means 1100 for driving a generator 1114 to produce electrical energy. After being delivered through the turbine, the low boiling point medium is then re-condensed to a liquid and delivered back down the well 1140 through the pipe system 1130 for the next vaporization cycle. This example embodiment, which may be referred to as a Sumrall energy cycle plant, may be entirely or substantially closed loop in design, and may not require a low temperature source as in the other thermoelectric generators, heat engines, and the like. Furthermore, this example embodiment may not require the use of a pump station, as the heat vapor can rise through the pipe system naturally and be gravity fed to the high temperature source. It is further appreciated that a low boiling point fluid may be employed in any of the other configurations, providing a gaseous interface at the hot junction rather than a fluid one.

In another example embodiment, the power generating means 1110 may be a Matteran energy cycle power plant. The Matteran energy cycle is generally a closed loop energy cycle that does not require the use of fluid feed pumps, and requires only low temperature heat source as a result of its use of a refrigerant instead of water as the heat transfer medium and a condensing mechanism (not shown) to recollect vapor, a heat exchanger (not shown) to heat the condensed material prior to delivery to the high temperature source for heating, connected through a series of controllable valves. Accordingly, with reference to FIG. 11, the power generating means 1110 may include a Matteran energy cycle plant. Thus, the fluid transfer medium in this example embodiment is a refrigerant as is known. Further, though not shown, the Matteran energy cycle plant may include at least one condenser in communication with the fluid return pipe 1134 to condense any remaining vapor to its liquid state. Further, though also not shown, the Matteran energy cycle plant may include at least one heat exchanger in communication with the fluid return pipe 1134 and downstream the previously described heat exchanger. Further, a valve system as is known may selectably control the fluid from the turbine 1112 through the condenser and through the heat exchanger prior to delivery to the bottom of the pipe system 1130 and the bottom of the hole 1140 for heating. After heating, the fluid, which may be substantially vaporized, may be delivered to the turbine 1112 of the power generating means 1110 for causing a rotational force therein and transferring to a generator 1114, as is known. After being delivered through the turbine 1112, utilized heat transfer medium would again be delivered down the fluid return pipe 1134 for subsequent cycles of condensing, heating by the heat exchanger, heating by the high temperature source, and redelivery to the power generating means 1110.

In yet other embodiments, a dry steam power plant or a flash cycle power plant may be employed as the power generating means 1110. In the dry cycle power plant embodiment steam is delivered from within the well (and in one embodiment is an open loop configuration delivering steam existing within the earth's crust) to a turbine 1112 for power generation. In the flash steam power plant, heated water is delivered from within the well (which may include a closed loop configuration as described above with reference to FIGS. 4-10 or an open loop configuration) to an additional flash tank (not shown) for creating steam prior to deliver to the turbine 1112. Similarly, a binary power plant or a combination flash/binary combined cycle plant, may employ a secondary working fluid in thermal communication with the pipe system 1130, which is then vaporized to drive a turbine 1112 and generator 1114. Heat may be transferred from a primary medium being pumped to and from the bottom of the well 1140 to the secondary working fluid by way of a heat exchanger or series of heat exchangers, as are known. The use of an additional working fluid allows having a fluid with different qualities interfacing with the turbine 1112 than is being pumped down the pipe system 1130 to the bottom of the well.

It is appreciated that where the term “pump station” is used describing these example embodiments, the “pump station” need not include an actual pump, as is known, or pumping capabilities. Accordingly, the “pump station” as used herein may simply refer to the mechanism operable to deliver the heat transfer medium through the pipe systems to one or both of the high temperature source and the low temperature source, and return to the power generation means, such as the thermoelectric generator, the example heat engines, the example turbine generators, and the like. For example, while any pump means as are known may be contemplated in some example embodiments, other example embodiments may be gravity fed, siphon-based, displacement-based, and the like.

It should be apparent that the foregoing relates only to exemplary embodiments of the invention and that numerous changes and modifications may be made herein without departing from the spirit and scope of the application as defined herein.

That which is claimed:

1. A system for producing electrical power comprising:
a power generating means comprising a hot junction and a cold junction;
a pump station;
a high temperature source thermally coupled by a first pipe system to the power generating means, wherein the high temperature source comprises heat from within the earth's surface, and wherein the first pipe system comprises a closed path between the pump station and the hot junction, the high temperature source is in thermal communication with the first pipe system therebetween; and
a low temperature source thermally coupled by a second pipe system to the cold junction, wherein the low temperature source comprises water from a body of water;
wherein the pump station is operable to cause a heat transfer medium to descend through the first pipe system to the high temperature source within the earth's surface and then to ascend through the first pipe system to the hot junction; and
wherein the power generating means generates electricity responsive in part to a temperature gradient between the hot junction and the cold junction.

2. The system of claim 1 wherein the high temperature source comprises one of a dry hole, an oil well, or a gas well.

3. The system of claim 1, wherein the low temperature source is below a thermocline of the body of water.

4. The system of claim 3, wherein the body of water is one of an ocean, a sea, a gulf, a river, a stream, a creek, a lake, a stream, or a spring.

5. The system of claim 1, wherein the first pipe system comprises a pipe comprising an interior pipe section and an exterior pipe section forming an annulus between the interior pipe section and the exterior pipe section.

6. The system of claim 5, wherein the heat transfer medium may be transported to the high temperature source through the annulus and transported from the high temperature source to the hot junction through the interior pipe.

7. The system of claim 1, wherein the power generation means comprises one of a Stirling engine or a Rankin engine.

8. The system of claim 1, wherein the power generation means comprises a closed loop heat engine comprising a turbine, a condenser for condensing spent heat transfer medium subsequent to passing the heat transfer medium through the turbine, a heat exchanger for re-heating the condensed spent heat transfer medium prior to delivering the heat transfer medium to the low temperature source.

9. A system for producing electrical power comprising:
a power generating means comprising a turbine;
a pump station;
a high temperature source coupled by a first pipe system to the turbine of the power generating means, wherein the high temperature source comprises heat from within the earth's surface, and wherein the first pipe system comprises a closed path between the pump station and the turbine, the high temperature source is in thermal communication with the first pipe system therebetween; and
a heat transfer medium;
wherein the pump station is operable to cause a heat transfer medium to descend through the first pipe system to the high temperature source within the earth's surface and then to ascend through the first pipe system to the power generating means; and
wherein the power generating means generates electricity responsive in part to the ascension of the heat transfer medium to causing a rotational force therein.

10. The system of claim 9, wherein the power generation means comprises one of a Stirling engine, a Rankine engine, a flash power plant, a dry steam power plant, a binary power plant, a flash/binary combined cycle power plant, a Sumrall energy cycle plant, or a Matteran energy cycle plant.

11. The system of claim 9, wherein the high temperature source substantially vaporizes the heat transfer medium, and wherein the vaporized heat transfer medium ascends through the first pipe system to the turbine.

12. The system of claim 9, wherein the pipe system comprises a heat pipe.

13. A system for producing electrical power comprising:
a power generating means comprising a turbine;
a pump station;
a high temperature source coupled by a first pipe system to the turbine of the power generating means, wherein the high temperature source comprises heat from within the earth's surface, and wherein the first pipe system comprises a closed path between the pump station and the turbine, the high temperature source is in thermal communication with the first pipe system therebetween; and
a heat transfer medium comprising a boiling point less than approximately 100 degrees Celsius;
wherein the pump station is operable to cause the heat transfer medium to descend through the first pipe system to the high temperature source within the earth's surface;
wherein upon the high temperature source substantially vaporizing the heat transfer medium, the vaporized heat transfer medium ascends through the first pipe system to the turbine; and
wherein the power generating means generates electricity responsive in part to the ascension of the vaporized heat transfer medium to the turbine causing a rotational force therein.

14. The system of claim 13, wherein the power generating means further comprises a generator rotatably coupled with the turbine.

15. The system of claim 13, wherein the heat transfer medium comprises isobutane.

16. The system of claim 13, wherein the turbine is in gaseous communication with the pipe system.

17. The system of claim 13, wherein the power generating means comprises one of a Sumrall energy cycle plant.

18. A method for producing electrical power comprising:
providing a power generating means comprising a turbine;
providing a pump station;
thermally coupling a high temperature source by a first pipe system to the turbine of the power generating means, wherein the high temperature source comprises heat from within the earth's surface, and wherein the first pipe system comprises a closed path between the pump station and the turbine, the high temperature source is in thermal communication with the first pipe system therebetween; and
causing a the heat transfer medium to descend through the first pipe system to the high temperature source within the earth's surface and then to ascend through the first pipe system to the power generating means; and
wherein the power generating means generates electricity responsive in part to the ascension of the heat transfer medium to causing a rotational force therein.

19. The method of claim 18, further comprising substantially vaporizing the heat transfer medium by the high temperature source, and wherein the vaporized heat transfer medium ascends through the first pipe system to the power generating means.

20. The method of claim 18, wherein the power generation means comprises one of a Stirling engine, a Rankine engine, a flash power plant, a dry steam power plant, a binary power plant, a flash/binary combined cycle power plant, a Sumrall energy cycle plant, or a Matteran energy cycle plant.
